(19) United States
(12) Patent Application Publication
(10) Pub. No.: US 2020/0185736 A1
(43) Pub. Date: Jun. 11, 2020

(54) FUEL CELL SYSTEM

(71) Applicant: TOYOTA JIDOSHA KABUSHIKI KAISHA, Toyota-shi (JP)

(72) Inventors: Masayuki ITO, Sunto-gun (JP); Hideyuki KUMEI, Sunto-gun (JP); Tomohiko KANEKO, Okazaki-shi (JP)

(73) Assignee: TOYOTA JIDOSHA KABUSHIKI KAISHA, Toyota-shi (JP)

(21) Appl. No.: 16/688,357

(22) Filed: Nov. 19, 2019

(30) Foreign Application Priority Data
Dec. 5, 2018 (JP) 2018-228387

(51) Int. Cl. H01M 8/04828; H01M 8/0432

(52) U.S. Cl. CPC H01M 8/0494; H01M 2250/20; H01M 8/0432

(57) ABSTRACT

A fuel cell system includes: a fuel cell unit; a temperature acquiring unit acquiring an ambient temperature of a first fuel cell stack of the fuel cell unit; and a power generation control unit. The power generation control unit is configured to, when required power for the fuel cell unit is less than a predetermined threshold value, temporarily stop power generation of the first fuel cell stack and to switch the first fuel cell stack from stopped power generation to power generation when a continuous power generation stopped time of the first fuel cell stack is greater than a predetermined time such that the continuous power generation stopped time is shorter when the ambient temperature is equal to or lower than a predetermined temperature based on a temperature at which liquid water in the first fuel cell stack freezes than when the ambient temperature is higher than the predetermined temperature.

### INCORPORATION BY REFERENCE

The disclosure of Japanese Patent Application No. 2018-228387 filed on Dec. 5, 2018 including the specification, drawings and abstract is incorporated herein by reference in its entirety.

### BACKGROUND

### 1. Technical Field

The disclosure relates to a fuel cell system.

### 2. Description of Related Art

A fuel cell system including a plurality of fuel cell stacks is known. For example, a fuel cell system in which the number of unit cells which are connected to a load out of a plurality of unit cells including a fuel cell is changed depending on change of the load is known (for example, see Japanese Unexamined Patent Application Publication No. 2003-178786 (JP 2003-178786 A)).

### SUMMARY

As described in JP 2003-178786 A, when the number of fuel cell stacks which are connected to a load is changed with change of the load, there may be a fuel cell stack that stops its power generation. In this case, it is conceivable that liquid water in the fuel cell stack that stops the power generation freezes, and it may be difficult to generate electric power even when it is intended for the fuel cell stack to generate electric power later.

The disclosure provides a technique of preventing liquid water in a fuel cell stack from freezing.

According to an aspect of the disclosure, there is provided a fuel cell system. The fuel cell system includes: a fuel cell unit including a first fuel cell stack and a second fuel cell stack; a temperature acquiring unit configured to acquire an ambient temperature of the first fuel cell stack; and a power generation control unit configured to control power generation of the first fuel cell stack and the second fuel cell stack based on required power for the fuel cell unit. The power generation control unit is configured to, when the required power is less than a predetermined threshold value, temporarily stop power generation of the first fuel cell stack and to switch the first fuel cell stack from stopped power generation to power generation when a continuous power generation stopped time of the first fuel cell stack is greater than a predetermined time such that the continuous power generation stopped time is shorter when the temperature acquired by the temperature acquiring unit is equal to or lower than a first predetermined temperature based on a temperature at which liquid water in the first fuel cell stack freezes than when the temperature acquired by the temperature acquiring unit is higher than the first predetermined temperature.

In the configuration, the power generation control unit may be configured to, when the required power is less than the predetermined threshold value and the temperature acquired by the temperature acquiring unit is equal to or lower than the first predetermined temperature, cause the first fuel cell stack to alternately perform power generation and stop power generation, cause the second fuel cell stack to perform power generation when the first fuel cell stack stops power generation, and cause the second fuel cell stack to stop power generation when the first fuel cell stack performs power generation.

In the configuration, the power generation control unit may be configured to cause the first fuel cell stack to keep power generation stopped and to cause the second fuel cell stack to continue power generation when the required power is less than the predetermined threshold value and a state in which the temperature acquired by the temperature acquiring unit is higher than the first predetermined temperature is maintained.

In the configuration, the power generation control unit may be configured to, when the required power is less than the predetermined threshold value, cause the first fuel cell stack and the second fuel cell stack to alternately perform power generation regardless of the temperature acquired by the temperature acquiring unit and to set a switching interval between stopped power generation and power generation of the first fuel cell stack and the second fuel cell stack to be longer when the temperature acquired by the temperature acquiring unit is higher than the first predetermined temperature than when the temperature acquired by the temperature acquiring unit is equal to or lower than the first predetermined temperature.

In the configuration, the power generation control unit may be configured to set the predetermined time to be shorter when the temperature acquired by the temperature acquiring unit is a low temperature within a temperature range than when the temperature acquired by the temperature acquiring unit is a high temperature within the temperature range. The temperature range may be a temperature range up to the first predetermined temperature.

In the configuration, the temperature acquiring unit may be configured to further acquire a temperature of the first fuel cell stack. The power generation control unit may be configured to, when the required power is less than the predetermined threshold value and the ambient temperature of the first fuel cell stack acquired by the temperature acquiring unit is equal to or lower than the first predetermined temperature, switch the first fuel cell stack from stopped power generation to power generation when the temperature of the first fuel cell stack acquired by the temperature acquiring unit becomes equal to or lower than a second predetermined temperature in a state in which the first fuel cell stack has stopped power generation.

According to another aspect of the disclosure, there is provided a fuel cell system. The fuel cell system includes: a fuel cell unit including a first fuel cell stack and a second fuel cell stack; a temperature acquiring unit configured to acquire a temperature of the first fuel cell stack; and a power generation control unit configured to control power generation of the first fuel cell stack and the second fuel cell stack based on required power for the fuel cell unit. The power generation control unit is configured to, when the required power is less than a predetermined threshold value, temporarily stop power generation of the first fuel cell stack and switch the first fuel cell stack from stopped power generation to power generation when the temperature of the first fuel cell stack acquired by the temperature acquiring unit is equal to or lower than a predetermined temperature based on a temperature at which liquid water in the first fuel cell stack freezes.

In the configuration, the temperature acquiring unit may be configured to further acquire a temperature of the second fuel cell stack. The power generation control unit may be configured to, when the required power is less than the predetermined threshold value, cause the second fuel cell stack to perform power generation when the first fuel cell stack stops power generation, cause the second fuel cell stack to stop power generation when the first fuel cell stack performs power generation, and to switch the second fuel cell stack from stopped power generation to power generation when the temperature of the second fuel cell stack acquired by the temperature acquiring unit when the second fuel cell stack stops power generation is equal to or lower than a predetermined temperature based on a temperature at which liquid water in the second fuel cell stack freezes.

According to the disclosure, it is possible to prevent liquid water in a fuel cell stack from freezing.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a fuel cell system according to a first embodiment;

FIG. 2 is a diagram schematically illustrating an electrical configuration of the fuel cell system according to the first embodiment;

FIG. 3 is a flowchart illustrating power generation control according to the first embodiment;

FIG. 4 is a diagram illustrating power generation control according to the first embodiment;

FIG. 5A is a timing chart illustrating power generation control according to the first embodiment;

FIG. 5B is a timing chart illustrating power generation control according to the first embodiment;

FIG. 6 is a flowchart illustrating power generation control according to a second embodiment;

FIG. 7A is a timing chart illustrating power generation control according to the second embodiment;

FIG. 7B is a timing chart illustrating power generation control according to the second embodiment;

FIG. 8 is a flowchart illustrating power generation control according to a third embodiment;

FIG. 9 is a diagram illustrating an example of a map which is used to determine a switching interval;

FIG. 10A is a timing chart illustrating power generation control according to the third embodiment;

FIG. 10B is a timing chart illustrating power generation control according to the third embodiment; and

FIG. 11 is a flowchart illustrating power generation control according to a fourth embodiment.

### DETAILED DESCRIPTION OF EMBODIMENTS

Hereinafter, embodiments of the disclosure will be described with reference to the accompanying drawings.

### [Configuration of Fuel Cell System]

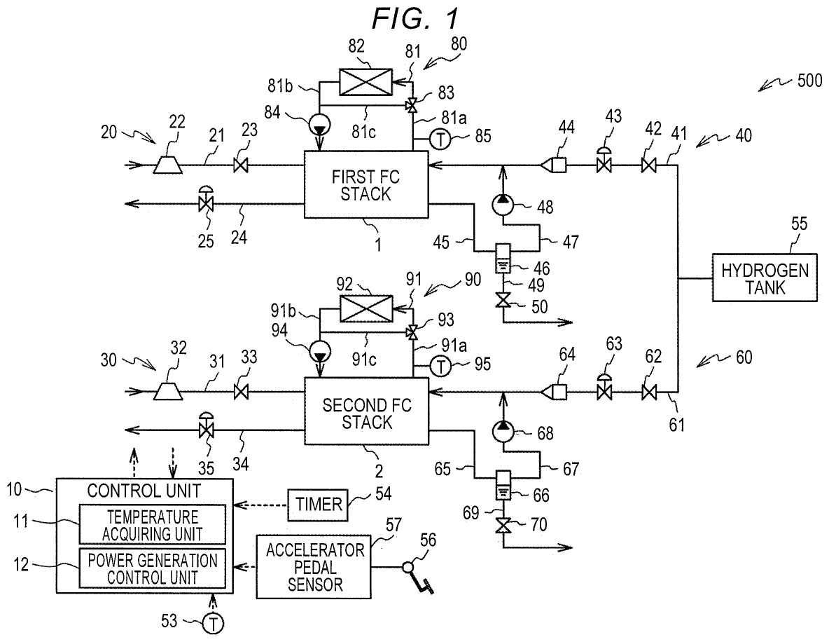

FIG. 1 is a diagram schematically illustrating a configuration of a fuel cell system according to a first embodiment. The fuel cell system is a power generation system that is used for a fuel-cell vehicle, a stationary fuel-cell device, and the like and outputs electric power in response to required power. In the following embodiment, it is assumed that the fuel cell system is mounted in a vehicle. As illustrated in FIG. 1, a fuel cell system 500 includes a first fuel cell stack 1 (hereinafter referred to as a first FC stack 1) and a second fuel cell stack 2 (hereinafter referred to as a second FC stack 2) which constitute a fuel cell unit, a control unit 10, cathode gas pipe systems 20 and 30, anode gas pipe systems 40 and 60, and refrigerant pipe systems 80 and 90.

The first FC stack 1 and the second FC stack 2 are solid polymer type fuel cells that are supplied with hydrogen (an anode gas) and air (a cathode gas) as reactant gases and generate electric power. The first FC stack 1 and the second FC stack 2 have a stacked structure in which a plurality of cells is stacked. Each cell includes a membrane-electrode assembly which is a power generator having electrodes disposed on both surfaces of an electrolyte membrane and a pair of separators between which the membrane-electrode assembly is interposed. The first FC stack 1 and the second FC stack 2 may have the same maximum output power or different maximum output powers. The first FC stack 1 and the second FC stack 2 may have the same number of cells stacked or different numbers of cells stacked.

The electrolyte membrane is a solid polymer membrane which is formed of a fluorine-based resin material or a hydrocarbon-based resin material having a sulfonate group and exhibits excellent proton conductivity in a wet state. The electrodes include carbon carriers and ionomers which are solid polymers having a sulfonate group and exhibit excellent proton conductivity in a wet state. The carbon carriers carry a catalyst (for example, platinum or a platinum-cobalt alloy) for promoting a power generation reaction. A manifold for allowing reactant gases to flow is provided in each cell. Reactant gases flowing in the manifold are supplied to a power generation region of each cell via gas flow passages which are provided in each cell.

The control unit 10 serves as a temperature acquiring unit 11 and a power generation control unit 12. A temperature detection signal is transmitted to the control unit 10 from a temperature sensor 53 that detects an outside air temperature around the vehicle in which the fuel cell system 500 is mounted. The temperature sensor 53 may be provided in an area in which the first FC stack 1 and the second FC stack 2 are accommodated and may detect the temperature in the area. The temperature acquiring unit 11 acquires ambient temperatures of the first FC stack 1 and the second FC stack 2 based on the temperature detection signal transmitted from the temperature sensor 53. The temperature acquiring unit 11 may acquire the ambient temperatures of the first FC stack 1 and the second FC stack 2 without correcting the temperature detection signal or may acquire the ambient temperatures of the first FC stack 1 and the second FC stack 2 by correcting the temperature detection signal.

An accelerator operation amount signal is transmitted to the control unit 10 from an accelerator pedal sensor 57 that detects an amount of operation of an accelerator pedal 56 (that is, an amount of depression of the accelerator pedal 56 by a driver). The power generation control unit 12 calculates required power for the fuel cell unit including the first FC stack 1 and the second FC stack 2 based on the accelerator operation amount signal and controls power generation of the first FC stack 1 and the second FC stack 2 by controlling the constituent units of the fuel cell system 500 which will be described later based on the calculated required power and the temperature acquired by the temperature acquiring unit 11. Here, the power generation control unit 12 first calculates required power for the whole fuel cell system 500 including the fuel cell unit based on the accelerator operation amount. When the fuel cell system 500 includes a secondary battery, the power generation control unit 12 may detect a state of charge of the secondary battery and calculate required power for the fuel cell unit in consideration of electric power which is charged or discharged by the secondary battery.

The cathode gas pipe system 20 supplies a cathode gas to the first FC stack 1 and discharges a cathode exhaust gas which has not been consumed in the first FC stack 1. The cathode gas pipe system 20 includes a cathode gas pipe 21, an air compressor 22, a switching valve 23, a cathode exhaust gas pipe 24, and a pressure regulator valve 25. The cathode gas pipe 21 is a pipe that is connected to a cathode inlet of the first FC stack 1. The air compressor 22 is connected to a cathode of the first FC stack 1 via the cathode gas pipe 21, takes outside air in, and supplies compressed air as a cathode gas to the first FC stack 1. The control unit 10 controls a flow rate of air which is supplied to the first FC stack 1 by controlling driving of the air compressor 22. The switching valve 23 is provided between the air compressor 22 and the first FC stack 1 and is opened and closed depending on a flow of air in the cathode gas pipe 21. For example, the switching valve 23 is normally closed and is opened when air with a predetermined pressure is supplied from the air compressor 22 to the cathode gas pipe 21. The cathode exhaust gas pipe 24 is a pipe that is connected to a cathode outlet of the first FC stack 1 and discharges a cathode exhaust gas to the outside of the fuel cell system 500. The pressure regulator valve 25 regulates a pressure of the cathode exhaust gas in the cathode exhaust gas pipe 24.

The cathode gas pipe system 30 supplies a cathode gas to the second FC stack 2 and discharges a cathode exhaust gas which has not been consumed in the second FC stack 2. The cathode gas pipe system 30 includes a cathode gas pipe 31, an air compressor 32, a switching valve 33, a cathode exhaust gas pipe 34, and a pressure regulator valve 35. The cathode gas pipe 31, the air compressor 32, the switching valve 33, the cathode exhaust gas pipe 34, and the pressure regulator valve 35 have the same functions as the cathode gas pipe 21, the air compressor 22, the switching valve 23, the cathode exhaust gas pipe 24, and the pressure regulator valve 25 of the cathode gas pipe system 20, respectively. Accordingly, the control unit 10 controls a flow rate of air which is supplied to the second FC stack 2 by controlling driving of the air compressor 32.

The anode gas pipe system 40 supplies an anode gas to the first FC stack 1 and discharges an anode exhaust gas which has not been consumed in the first FC stack 1. The anode gas pipe system 40 includes an anode gas pipe 41, a switching valve 42, a regulator 43, an injector 44, an anode exhaust gas pipe 45, a gas-liquid separator 46, an anode gas circulation pipe 47, a circulation pump 48, an anode drainage pipe 49, and a drainage valve 50. The anode gas pipe 41 is a pipe that connects a hydrogen tank 55 to an anode inlet of the first FC stack 1. The hydrogen tank 55 is connected to the anode of the first FC stack 1 via the anode gas pipe 41 and supplies hydrogen stored in the tank to the first FC stack 1. The switching valve 42, the regulator 43, and the injector 44 are sequentially arranged in the anode gas pipe 41 in that order from upstream. The switching valve 42 is switched in accordance with a command from the control unit 10 and controls flowing of hydrogen from the hydrogen tank 55 to the upstream side of the injector 44. The regulator 43 is a decompression valve that regulates a pressure of hydrogen upstream from the injector 44. The injector 44 is an electromagnetically driven switching valve of which a valve body is electromagnetically driven based on a drive cycle and a valve opening time which are set by the control unit 10. The control unit 10 controls a flow rate of hydrogen which is supplied to the first FC stack 1 by controlling the drive cycle and/or the valve opening time of the injector 44 and driving of the circulation pump 48 which will be described later.

The anode exhaust gas pipe 45 is a pipe that connects an anode outlet of the first FC stack 1 to the gas-liquid separator 46 and guides an anode exhaust gas including unreacted gas (such as hydrogen and nitrogen) which has not been used for a power generation reaction to the gas-liquid separator 46. The gas-liquid separator 46 separates the anode exhaust gas into a gas component and moisture, guides the gas component to the anode gas circulation pipe 47, and guides the moisture to the anode drainage pipe 49. The anode gas circulation pipe 47 is connected to the anode gas pipe 41 downstream from the injector 44. The circulation pump 48 is provided in the anode gas circulation pipe 47. Hydrogen included in the gas component separated by the gas-liquid separator 46 is supplied to the anode gas pipe 41 by the circulation pump 48. The circulation pump 48 operates in accordance with a command from the control unit 10. The anode drainage pipe 49 is a pipe that discharges the moisture separated by the gas-liquid separator 46 to the outside of the fuel cell system 500. The drainage valve 50 is provided in the anode drainage pipe 49 and is opened and closed in accordance with a command from the control unit 10.

The anode gas pipe system 60 supplies an anode gas to the second FC stack 2 and discharges an anode exhaust gas which has not been consumed in the second FC stack 2. The anode gas pipe system 60 includes an anode gas pipe 61, a switching valve 62, a regulator 63, an injector 64, an anode exhaust gas pipe 65, a gas-liquid separator 66, an anode gas circulation pipe 67, a circulation pump 68, an anode drainage pipe 69, and a drainage valve 70. The anode gas pipe 61, the switching valve 62, the regulator 63, the injector 64, the anode exhaust gas pipe 65, the gas-liquid separator 66, the anode gas circulation pipe 67, the circulation pump 68, the anode drainage pipe 69, and the drainage valve 70 have the same functions as the anode gas pipe 41, the switching valve 42, the regulator 43, the injector 44, the anode exhaust gas pipe 45, the gas-liquid separator 46, the anode gas circulation pipe 47, the circulation pump 48, the anode drainage pipe 49, and the drainage valve 50 of the anode gas pipe system 40, respectively. Accordingly, the control unit 10 controls a flow rate of hydrogen which is supplied to the second FC stack 2 by controlling a drive cycle and/or a valve opening time of the injector 64 and controlling driving of the circulation pump 68.

The refrigerant pipe system 80 circulates a refrigerant for cooling the first FC stack 1 to the first FC stack 1. The refrigerant pipe system 80 includes a refrigerant pipe 81, a radiator 82, a three-way valve 83, a circulation pump 84, and a temperature sensor 85. The refrigerant pipe 81 is a pipe that circulates the refrigerant for cooling the first FC stack 1 and includes an upstream pipe 81a, a downstream pipe 81b, and a bypass pipe 81c. The upstream pipe 81a connects a refrigerant outlet of the first FC stack 1 to an inlet of the radiator 82. The downstream pipe 81b connects a refrigerant inlet of the first FC stack 1 to an outlet of the radiator 82. One end of the bypass pipe 81c is connected to the upstream pipe 81a via the three-way valve 83 and the other end is connected to the downstream pipe 81b. The control unit 10 controls an amount of refrigerant flowing into the bypass pipe 81c and controls an amount of refrigerant flowing into the radiator 82 by controlling ON/OFF of the three-way valve 83.

The radiator 82 is provided in the refrigerant pipe 81 and cools the refrigerant by exchanging heat between the refrigerant flowing in the refrigerant pipe 81 and the outside air. The circulation pump 84 is disposed in the downstream pipe 81b downstream from a point is connected to the bypass pipe 81c, and is driven in accordance with a command from the control unit 10. The temperature sensor 85 is provided in the upstream pipe 81a, detects a temperature of the refrigerant, and transmits a temperature detection signal to the control unit 10.

The refrigerant pipe system 90 circulates a refrigerant for cooling the second FC stack 2 to the second FC stack 2. The refrigerant pipe system 90 includes a refrigerant pipe 91, a radiator 92, a three-way valve 93, a circulation pump 94, and a temperature sensor 95. The refrigerant pipe 91, the radiator 92, the three-way valve 93, the circulation pump 94, and the temperature sensor 95 have the same functions as the refrigerant pipe 81, the radiator 82, the three-way valve 83, the circulation pump 84, and the temperature sensor 85 of the refrigerant pipe system 80, respectively. Accordingly, the temperature sensor 95 detects a temperature of the refrigerant and transmits a temperature detection signal to the control unit 10. The control unit 10 controls switching of the three-way valve 93 and driving of the circulation pump 94.

The control unit 10 (that is, the temperature acquiring unit 11) may acquire the temperatures of the first FC stack 1 and the second FC stack 2 based on the temperature detection signals transmitted from the temperature sensors 85 and 95. In this case, the temperature acquiring unit 11 may acquire the temperatures of the first FC stack 1 and the second FC stack 2 without correcting the temperature detection signals or may acquire the temperatures of the first FC stack 1 and the second FC stack 2 by correcting the temperature detection signals.

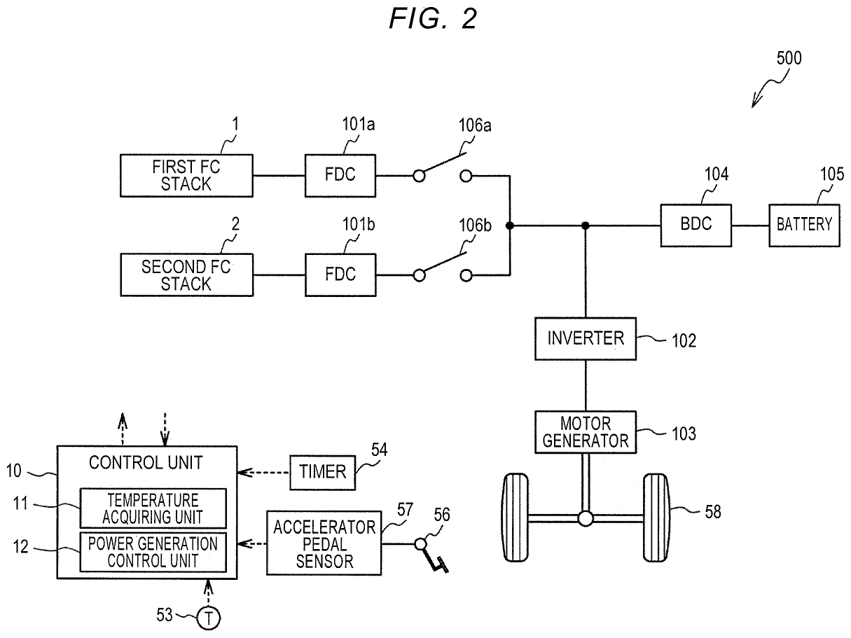

FIG. 2 is a diagram schematically illustrating an electrical configuration of the fuel cell system according to the first embodiment. The fuel cell system 500 includes FDCs 101a and 101b, an inverter 102, a motor generator 103, a BDC 104, a battery 105, and switches 106a and 106b in addition to the control unit 10.

The FDCs 101a and 101b are DC/DC converters. The FDC 101a transforms an output voltage of the first FC stack 1 and supplies the transformed output voltage to the inverter 102 and the BDC 104. The FDC 101b transforms an output voltage of the second FC stack 2 and supplies the transformed output voltage to the inverter 102 and the BDC 104. The BDC 104 is a DC/DC converter. The battery 105 is a secondary battery that is chargeable and dischargeable. The BDC 104 can adjust a DC voltage from the battery 105 and output the adjusted DC voltage to the inverter 102, and can adjust DC voltages from the first FC stack 1 and the second FC stack 1 and a voltage from the motor generator 103 converted into a DC voltage by the inverter 102 and output the adjusted voltages to the battery 105. The inverter 102 is a DC/AC inverter, converts DC power output from the first FC stack 1, the second FC stack 2, and the battery 105 into AC power, and supplies the AC power to the motor generator 103. The motor generator 103 drives vehicle wheels 58. The switches 106a and 106b are opened and closed in accordance with a command from the control unit 10 and switch between electrical connection and disconnection of the first FC stack 1 and the second FC stack 2 and the motor generator 103 and the battery 105.

The control unit 10 is an electronic control unit (ECU) which is constituted by a microcomputer including a central processing unit (CPU), a random access memory (RAM), a read only memory (ROM), and a storage unit. The storage unit is a nonvolatile memory such as a hard disk drive (HDD) or a flash memory. The control unit 10 comprehensively controls the constituent units of the fuel cell system 500 and controls operation of the fuel cell system 500.

As described above, the control unit 10 serves as the temperature acquiring unit 11 and the power generation control unit 12. The temperature acquiring unit 11 acquires the ambient temperatures of the first FC stack 1 and the second FC stack 2 based on the temperature detection signal transmitted from the temperature sensor 53. The power generation control unit 12 calculates required power for the fuel cell unit including the first FC stack 1 and the second FC stack 2 based on an accelerator operation amount signal and controls power generation of the first FC stack 1 and the second FC stack 2 based on the calculated required power and the temperatures acquired by the temperature acquiring unit 11.

For example, the power generation control unit 12 controls a flow rate of a cathode gas which is supplied to the first FC stack 1 and the second FC stack 2 by controlling the air compressors 22 and 32 and the like, and controls a flow rate of an anode gas which is supplied to the first FC stack 1 and the second FC stack 2 by controlling the injectors 44 and 64, the circulation pumps 48 and 68, and the like. The power generation control unit 12 switches the switches 106a and 106b to an ON state (a connected state) when the first FC stack 1 and the second FC stack 2 are allowed to generate electric power, and switches the switches 106a and 106b to an OFF state (a disconnected state) when the first FC stack 1 and the second FC stack 2 stop power generation. Here, a configuration in which the switches 106a and 106b are provided separately from the FDCs 101a and 101b is employed, but the disclosure is not limited thereto. For example, by providing switching elements in the FDCs 101a and 101b and causing the power generation control unit 12 to control the switching elements of the FDCs 101a and 101b, switching between electrical connection and disconnection of the first FC stack 1, the second FC stack 2, the motor generator 103, and the battery 105 may be carried out.

Signals associated with measured times obtained by measuring a power generation time and a power generation stopped time of the first FC stack 1 and a power generation time and a power generation stopped time of the second FC stack 2 are transmitted from a timer 54 to the control unit 10. That is, the timer 54 measures the power generation time and the power generation stopped time of the first FC stack 1 and the power generation time and the power generation stopped time of the second FC stack 2. The timer 54 may measure the power generation times and the power generation stopped times of the first FC stack 1 and the second FC stack 2 based on ON/OFF of the switches 106a and 106b.

### [Power Generation Control]

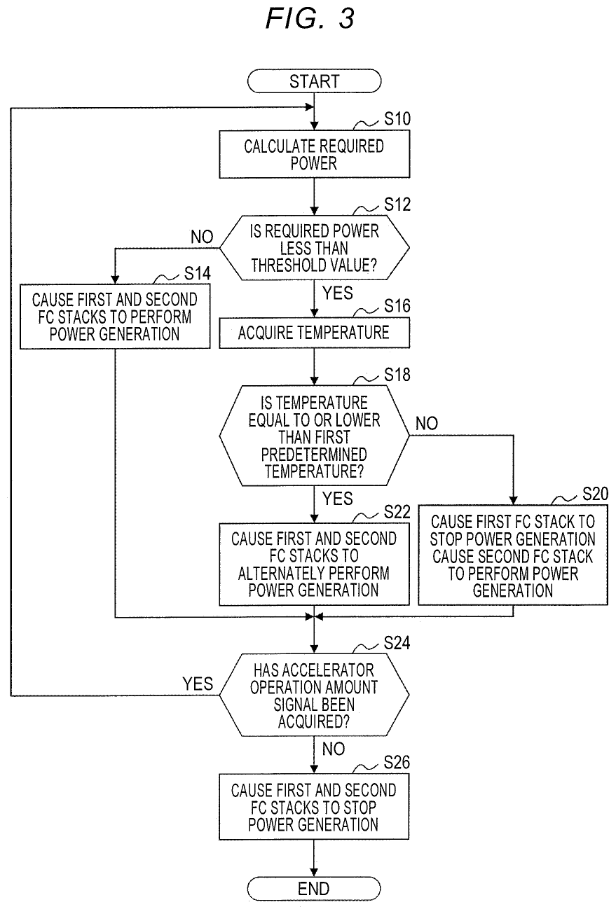

FIG. 3 is a flowchart illustrating power generation control according to the first embodiment. As illustrated in FIG. 3, the control unit 10 calculates required power for the whole FC stack based on an accelerator operation amount signal with a nonzero operation amount (Step S10). For example, the control unit 10 calculates the required power for the whole FC stack based on the accelerator operation amount signal with reference to a map indicating a correlation between the accelerator operation amount signal and the required power, which is stored in the storage unit.

Subsequently, the control unit 10 determines whether the calculated required power is less than a predetermined threshold value (Step S12). The threshold value may be set to, for example, a value with which it is difficult to satisfy the required power by power generation of only one of the first FC stack 1 and the second FC stack 2. For example, when the first FC stack 1 and the second FC stack 2 have substantially the same maximum output power, the threshold value may be set to a value which is equal to or greater than 40% and equal to or less than 50% of a total maximum output power of the maximum output power of the first FC stack 1 and the maximum output power of the second FC stack 2 or may be set to a value which is equal to or greater than 45% and equal to or less than 50% thereof. The threshold value is stored, for example, in the storage unit of the control unit 10. The threshold value may not be a value with which it is difficult to satisfy the required power by power generation of only one of the first FC stack 1 and the second FC stack 2. For example, in consideration of power generation efficiency of the first FC stack 1 and the second FC stack 2, a value in which power generation efficiency by power generation of only one of the first FC stack 1 and the second FC stack 2 is better than that by power generation of both FC stacks may be set as the threshold value when the required power is equal to or less than the threshold value.

When it is determined in Step S12 that the required power is equal to or greater than the threshold value (NO in Step S12), the control unit 10 causes both the first FC stack 1 and the second FC stack 2 to generate electric power such that the required power is satisfied (Step S14). That is, the control unit 10 drives the air compressor 22, the injector 44, and the like such that air and hydrogen are supplied to the first FC stack 1, and controls the air compressor 32, the injector 64, and the like such that air and hydrogen are supplied to the second FC stack 2. At this time, the control unit 10 switches the switches 106a and 106b to the ON state to electrically connect the first FC stack 1 and the second FC stack 2 to the motor generator 103.

When it is determined in Step S12 that the required power is less than the threshold value (YES in Step S12), the control unit 10 acquires the ambient temperatures of the first FC stack 1 and the second FC stack 2 based on the temperature detection signal transmitted from the temperature sensor 53 (Step S16). Subsequently, the control unit 10 determines whether the temperature acquired in Step S16 is equal to or lower than a first predetermined temperature based on a temperature at which liquid water in the first FC stack 1 freezes (Step S18). The first predetermined temperature may be set to 0° C., a temperature within a range of 0° C.±5° C., or a temperature within a range of 0° C.±2° C.

When it is determined that the temperature acquired in Step S16 is higher than the first predetermined temperature (NO in Step S18), the control unit 10 causes the first FC stack 1 to stop power generation and causes the second FC stack 2 to perform power generation such that the required power is satisfied by the second FC stack 2 (Step S20). At this time, the control unit 10 switches the switch 106b to the ON state and switches the switch 106a to the OFF state. The control unit 10 drives the air compressor 32, the injector 64, and the like such that an amount of air and an amount of hydrogen which are required for power generation for satisfying the required power are supplied to the second FC stack 2. The control unit 10 may stop driving of the air compressor 22, the injector 44, and the like or may drive them.

On the other hand, when it is determined that the temperature acquired in Step S16 is equal to or lower than the first predetermined temperature (YES in Step S18), the control unit 10 causes the first FC stack 1 and the second FC stack 2 to alternately perform power generation every predetermined time (Step S22). For example, the control unit 10 switches the first FC stack 1 and the second FC stack 2 between power generation and stopped power generation every predetermined time based on a measured time which is measured by a timer 54 that measures power generation times and power generation stopped times of the first FC stack 1 and the second FC stack 2.

When the first FC stack 1 is caused to stop power generation and the second FC stack 2 is caused to perform power generation, the control unit 10 switches the switch 106a to the OFF state and switches the switch 106b to the ON state. When the first FC stack 1 is caused to perform power generation and the second FC stack 2 is caused to stop power generation, the control unit 10 switches the switch 106a to the ON state and switches the switch 106b to the OFF state. When the first FC stack 1 is caused to stop power generation and the second FC stack 2 is caused to perform power generation, the control unit 10 drives the air compressor 32, the injector 64, and the like such that an amount of air and an amount of hydrogen which are required for power generation for satisfying the required power are supplied to the second FC stack 2. When the first FC stack 1 is caused to perform power generation and the second FC stack 2 is caused to stop power generation, the control unit 10 drives the air compressor 22, the injector 44, and the like such that an amount of air and an amount of hydrogen which are required for power generation for satisfying the required power are supplied to the first FC stack 1. When the first FC stack 1 is caused to stop power generation and the second FC stack 2 is caused to stop power generation, the control unit 10 may stop driving of the air compressors 22 and 32, the injectors 44 and 64, and the like or may drive them.

Then, the control unit 10 determines whether an accelerator operation amount signal with a nonzero operation amount continues to be acquired from the accelerator pedal sensor 57 (Step S24). When an accelerator operation amount signal with a nonzero operation amount continues to be acquired (YES in Step S24), the control unit 10 returns to Step S10. On the other hand, when an accelerator operation amount signal with a nonzero operation amount is not acquired (NO in Step S24), that is, when an accelerator operation amount signal with a zero operation amount is acquired, the control unit 10 causes the first FC stack 1 and the second FC stack 2 to stop power generation (Step S26) and ends the power generation control.

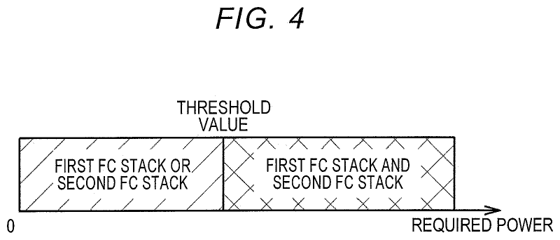

FIG. 4 is a diagram illustrating power generation control according to the first embodiment. When required power for the overall FC stacks is less than a predetermined threshold value as illustrated in FIG. 4, one of the first FC stack 1 and the second FC stack 2 is caused to perform power generation and the other is caused to stop power generation. When the required power is equal to or greater than the predetermined threshold value, both the first FC stack 1 and the second FC stack 2 are caused to perform power generation.

In this way, when the required power is small such as less than the predetermined threshold value, the required power is satisfied by causing one of the first FC stack 1 and the second FC stack 2 to perform power generation. When the required power is large such as equal to or greater than the predetermined threshold value, the required power is satisfied by causing both the first FC stack 1 and the second FC stack 2 to perform power generation.

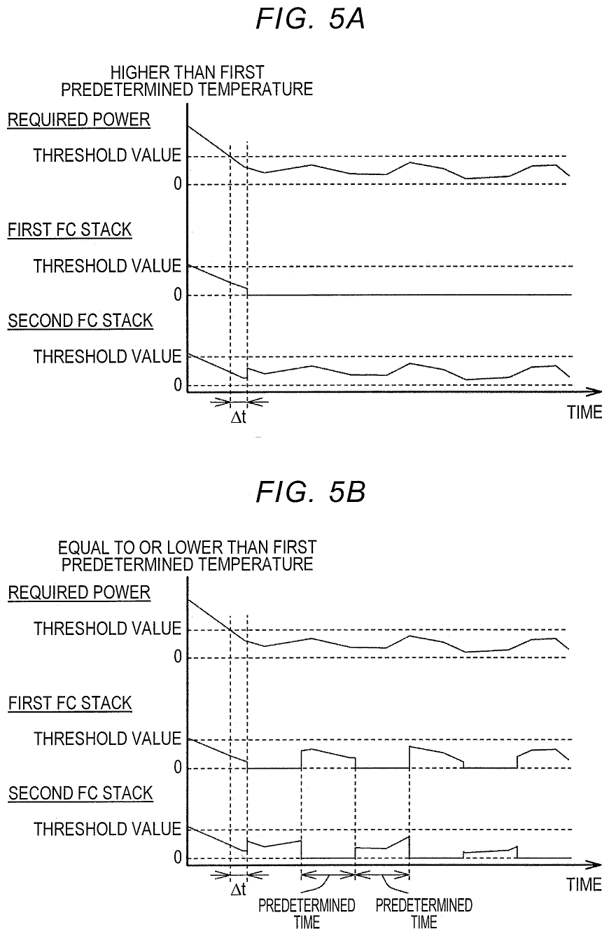

FIGS. 5A and 5B are timing charts illustrating power generation control according to the first embodiment. FIG. 5A is a timing chart illustrating Steps S18 and S20 in FIG. 3, and FIG. 5B is a timing chart illustrating Steps S18 and S22 in FIG. 3.

As illustrated in FIG. 5A, when the required power is less than a predetermined threshold value and the ambient temperatures of the first FC stack 1 and the second FC stack 2 are higher than the first predetermined temperature, the required power is satisfied by causing the first FC stack 1 to stop power generation and causing the second FC stack 2 to perform power generation. When the required power is small such as less than the predetermined threshold value, the required power can be satisfied by power generation of one of the first FC stack 1 and the second FC stack 2 and thus it is possible to shorten the power generation time of the first FC stack 1 and thus to improve durability by causing the first FC stack 1 to stop power generation. For various reasons such as power generation efficiency which is better when only the second FC stack 2 is caused to perform power generation than when both the first FC stack 1 and the second FC stack 2 are caused to perform power generation, the first FC stack 1 may be caused to stop power generation.

As illustrated in FIG. 5B, when the required power is less than a predetermined threshold value and the ambient temperatures of the first FC stack 1 and the second FC stack 2 are equal to or lower than the first predetermined temperature, the required power is satisfied by causing the first FC stack 1 and the second FC stack 2 to alternately perform power generation. That is, when the first FC stack 1 is caused to stop power generation, the required power is satisfied by causing the second FC stack 2 to perform power generation. When the second FC stack 2 is caused to stop power generation, the required power is satisfied by causing the first FC stack 1 to perform power generation. Switching of the first FC stack 1 and the second FC stack 2 between power generation and stopped power generation can be performed based on the measured time of the timer 54. For example, the first FC stack 1 and the second FC stack 2 may be caused to alternately perform power generation at intervals of 30 minutes. That is, the predetermined time may be set to 30 minutes. The predetermined time is not limited to 30 minutes and may be set to several minutes to several tens of minutes such as 5 minutes or 10 minutes or may be set to several hours such as one hour or two hours. When the predetermined time is short, it is possible to effectively curb a decrease in temperature of the FC stack which is caused to stop power generation and to curb degradation in power generation performance due to freezing. On the other hand, when the predetermined time is long, it is possible to curb an increase in power consumption due to switching of power generation. In the first FC stack 1 and the second FC stack 2, the power generation time and the power generation stopped time may be set to the same length or may be set to different lengths.

As described above with reference to FIG. 5A, when the required power is less than the predetermined threshold value, it is possible to improve durability by causing the first FC stack 1 to stop power generation. However, when the ambient temperatures of the first FC stack 1 and the second FC stack 2 are equal to or lower than a first predetermined temperature based on the temperature at which liquid water in the first FC stack 1 freezes and the first FC stack 1 stops power generation for a long time, the temperature of the first FC stack 1 may decrease and liquid water in the first FC stack 1 may freeze. In this case, when the required power becomes equal to or greater than the predetermined threshold value and it is intended to cause the first FC stack 1 to perform power generation, a gas flow passage of the first FC stack 1 may be clogged due to freezing of liquid water and it may be difficult to cause the first FC stack 1 to perform power generation.

Therefore, as illustrated in FIG. 5B, when the ambient temperatures of the first FC stack 1 and the second FC stack 2 are equal to or lower than the first predetermined temperature, the first FC stack 1 is caused to alternately stop and perform power generation and the power generation stopped time of the first FC stack 1 is set to be shorter than that when the ambient temperatures of the first FC stack 1 and the second FC stack 2 are higher than the first predetermined temperature. Accordingly, by curbing a decrease in temperature of the first FC stack 1, it is possible to prevent liquid water in the first FC stack 1 from freezing and to prevent difficulty in power generation of the first FC stack 1 even when the required power is equal to or greater than the predetermined threshold value.

According to the first embodiment, as illustrated in FIGS. 5A and 5B, when the required power is less than the predetermined threshold, value and the ambient temperature of the first FC stack 1 is equal to or lower than the first predetermined temperature, the control unit 10 switches the first FC stack 1 from stopped power generation to power generation when the power generation stopped time of the first FC stack 1 is equal to or greater than a predetermined time such that the power generation stopped time of the first FC stack 1 becomes shorter than that when the ambient temperature is higher than the first predetermined temperature. Accordingly, by curbing a decrease in temperature of the first FC stack 1, it is possible to prevent liquid water in the first FC stack 1 from freezing and to prevent difficulty in power generation of the first FC stack 1 even when the required power is equal to or greater than the predetermined threshold value.

The first predetermined temperature may be set to 0° C., may be set to a temperature within a range of 0° C.±5° C., or may be set to a temperature within a range of 0° C.±2° C. When the first predetermined temperature is set to a value higher than 0° C., it is possible to reliably prevent liquid water in the first FC stack 1 from freezing. When the first predetermined temperature is set to a value lower than 0° C., liquid water in the first FC stack 1 does not immediately freeze and thus it is possible to prevent liquid water in the first FC stack 1 from freezing. Depending on a place to which the temperature sensor 53 is attached, the temperature of the first FC stack 1 may be higher or lower than the temperature detected by the temperature sensor 53.

As illustrated in FIG. 5B, when the required power is less than the predetermined threshold value and the ambient temperature of the first FC stack 1 is equal to or lower than the first predetermined temperature, the control unit 10 causes the first FC stack 1 to alternately perform power generation and stop power generation, causes the second FC stack 2 to perform power generation when the first FC stack 1 is caused to stop power generation, and causes the second FC stack 2 to stop power generation when the first FC stack 1 is caused to perform power generation. Accordingly, it is possible to shorten the power generation time of the second FC stack 2 and thus to improve durability of the second FC stack 2. When the first FC stack 1 is caused to perform power generation, the second FC stack 2 may not be caused to stop power generation and the second FC stack 2 may be caused to continuously perform power generation.

As illustrated in FIG. 5A, when the required power is less than the predetermined threshold value and a state in which the ambient temperature of the first FC stack 1 is higher than the first predetermined temperature is maintained, the control unit 10 may cause the first FC stack 1 to keep power generation stopped and cause the second FC stack 2 to continue power generation. At the time of switching between stopped power generation and power generation, electric power is consumed to perform scavenging the FC stacks, or the like. Accordingly, by causing the first FC stack 1 to continuously stop power generation and causing the second FC stack 2 to continuously perform power generation as described above, it is possible to curb an increase in power consumption.

As illustrated in FIG. 5B, when the required power is less than the predetermined threshold value and the ambient temperature of the first FC stack 1 is equal to or lower than the first predetermined temperature, it is preferable that the power generation stopped time and the power generation time in the first FC stack 1 and the second FC stack 2 be repeated in the same length. Accordingly, it is possible to prevent the second FC stack 2 from stopping power generation for a long time and to prevent liquid water in the second FC stack 2 from freezing. The same length of the power generation stopped time and the power generation time does not refer to the completely same length, and the power generation stopped time and the power generation time may have slightly different lengths as long as freezing of liquid water can be curbed to the same extent in the first FC stack 1 and the second FC stack 2.

As illustrated in FIGS. 5A and 5B, the control unit 10 may cause the first FC stack 1 to stop power generation after a time Δt has elapsed after the required power becomes less than the predetermined threshold value. This is because that, when a state in which the required power is less than the predetermined threshold value has been maintained over the time Δ, the state in which the required power is less than the predetermined threshold value is estimated to be maintained thereafter and thus it is preferable to start control for causing the first FC stack 1 to stop power generation.

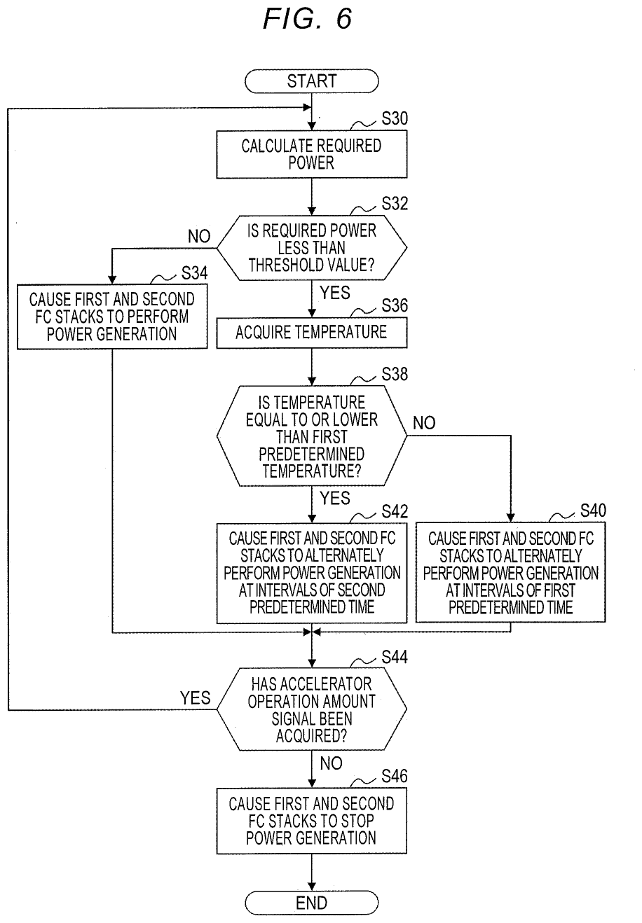

A configuration of a fuel cell system according to a second embodiment is the same as illustrated in FIG. 1 according to the first embodiment, and an electrical configuration thereof is the same as illustrated in FIG. 2 according to the first embodiment, and thus description thereof will not be repeated. FIG. 6 is a flowchart illustrating power generation control according to the second embodiment. Steps S30 to S38 in FIG. 6 are the same as Steps S10 to S18 in FIG. 3 according to the first embodiment and thus description thereof will not be repeated.

When it is determined that the temperature acquired in Step S36 is higher than the first predetermined temperature (NO in Step S38), the control unit 10 causes the first FC stack 1 and the second FC stack 2 to alternately perform power generation every first predetermined time (Step S40). On the other hand, when it is determined that the temperature acquired in Step S36 is equal to or lower than the first predetermined temperature (YES in Step S38), the control unit 10 causes the first FC stack 1 and the second FC stack 2 to alternately perform power generation every second predetermined time which is shorter than the first predetermined time (Step S42). Similarly to the first embodiment, the control unit 10 can switch the first FC stack 1 and the second FC stack 2 between power generation and stopped power generation based on a measured time which is measured by a timer 54. Thereafter, the control unit 10 performs Steps S44 and S46. Here, Steps S44 and S46 are the same as Steps S24 and S26 in FIG. 3 according to the first embodiment and thus description thereof will not be repeated.

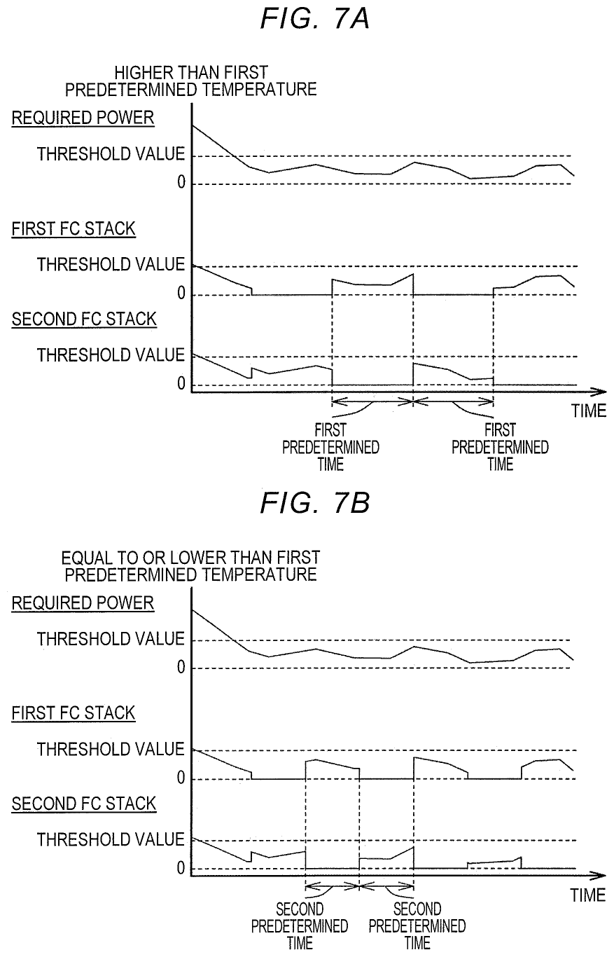

FIGS. 7A and 7B are timing charts illustrating power generation control according to the second embodiment. FIG. 7A is a timing chart illustrating Steps S38 and S40 in FIG. 6, and FIG. 7B is a timing chart illustrating Steps S38 and S42 in FIG. 6.

As illustrated in FIG. 7A, when the required power is less than a predetermined threshold value and the ambient temperatures of the first FC stack 1 and the second FC stack 2 are higher than the first predetermined temperature, the required power is satisfied by causing the first FC stack 1 and the second FC stack 2 to alternately perform power generation every first predetermined time. Switching of the first FC stack 1 and the second FC stack 2 between stopped power generation and power generation can be performed based on the measured time of the timer 54. For example, the first FC stack 1 and the second FC stack 2 may be caused to alternately perform power generation every two hours.

As illustrated in FIG. 7B, when the required power is less than the predetermined threshold value and the ambient temperatures of the first FC stack 1 and the second FC stack 2 are equal to or lower than the first predetermined temperature, the required power is satisfied by causing the first FC stack 1 and the second FC stack 2 to alternately perform power generation every second predetermined time which is shorter than the first predetermined time. Switching of the first FC stack 1 and the second FC stack 2 between stopped power generation and power generation can be performed based on the measured time of the timer 54. For example, the first FC stack 1 and the second FC stack 2 may be caused to alternately perform power generation every 30 minutes.

According to the second embodiment, as illustrated in FIGS. 7A and 7B, the control unit 10 causes the first FC stack 1 and the second FC stack 2 to alternately perform power generation regardless of the ambient temperatures of the first FC stack 1 and the second FC stack 2 when the required power is less than the predetermined threshold value. At this time, when the ambient temperature of the first FC stack 1 is higher than the first predetermined temperature, the control unit 10 sets a switching interval of the first FC stack 1 and the second FC stack 2 between stopped power generation and power generation to be longer than that when the ambient temperature of the first FC stack 1 is equal to or lower than the first predetermined temperature. Even when the ambient temperature of the first FC stack 1 is higher than the first predetermined temperature, it is possible to decrease the power generation time of the second FC stack 2 and thus to improve durability in comparison with the first embodiment by causing the first FC stack 1 and the second FC stack 2 to alternately perform power generation. As described above, electric power is consumed for scavenging the FC stacks when switching between stopped power generation and power generation is performed. Accordingly, when the ambient temperature of the first FC stack 1 is higher than the first predetermined temperature, it is possible to curb an increase in power consumption by setting the switching interval of the first FC stack 1 and the second FC stack 2 between stopped power generation and power generation to be longer than that when the ambient temperature of the first FC stack 1 is equal to or lower than the first predetermined temperature.

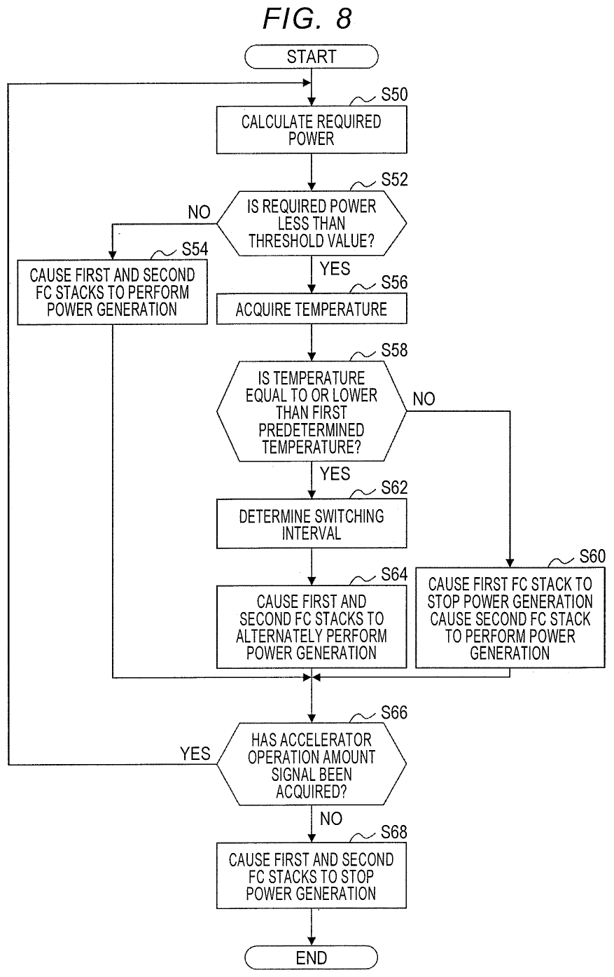

A configuration of a fuel cell system according to a third embodiment is the same as illustrated in FIG. 1 according to the first embodiment, and an electrical configuration thereof is the same as illustrated in FIG. 2 according to the first embodiment, and thus description thereof will not be repeated. FIG. 8 is a flowchart illustrating power generation control according to the third embodiment. Steps S50 to S60 in FIG. 8 are the same as Steps S10 to S20 in FIG. 3 according to the first embodiment and thus description thereof will not be repeated.

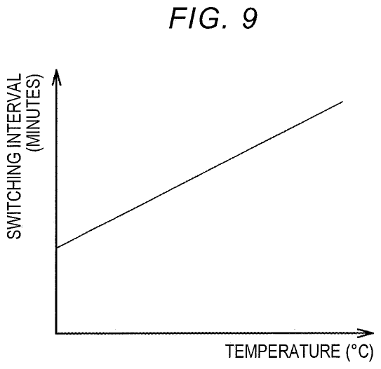

When it is determined that the temperature acquired in Step S56 is equal to or lower than the first predetermined temperature (YES in Step S58), the control unit 10 determines a switching interval at which the first FC stack 1 and the second FC stack 2 switch their power generation (Step S62). FIG. 9 illustrates an example of a map which is used to determine the switching interval. As illustrated in FIG. 9, the control unit 10 stores a map in which a temperature and a switching interval are correlated with each other in the storage unit thereof in advance. As the temperature decreases, the switching interval decreases in comparison with a case in which the temperature increases. The control unit 10 determines the switching interval using the temperature acquired in Step S56 and the map illustrated in FIG. 9.

Subsequently, the control unit 10 causes the first FC stack 1 and the second FC stack 2 to alternately perform power generation using the switching interval determined in Step S62 (Step S64). Similarly to the first embodiment, the control unit 10 can switch the first FC stack 1 and the second FC stack 2 between stopped power generation and power generation based on a measured time which is measured by a timer 54. Thereafter, the control unit 10 performs Steps S66 and S68. Here, Steps S66 and S68 are the same as Steps S24 and S26 in FIG. 3 according to the first embodiment and thus description thereof will not be repeated.

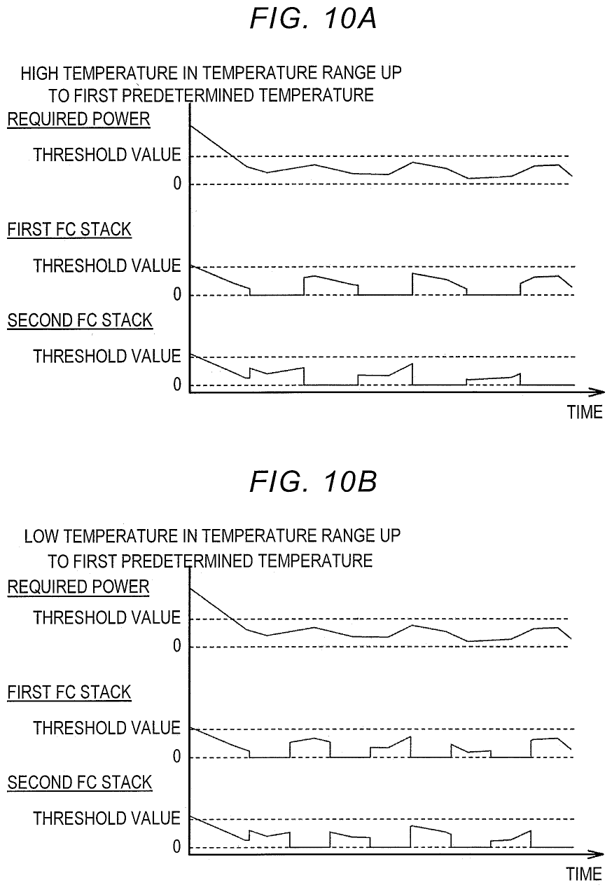

FIGS. 10A and 10B are timing charts illustrating power generation control according to the third embodiment. FIGS. 10A and 10B are timing charts illustrating Steps S58, S62, and S64 in FIG. 8, where FIG. 10A is a timing chart when the ambient temperatures of the first FC stack 1 and the second FC stack 2 are high in a temperature range up to the first predetermined temperature and FIG. 10B is a timing chart when the ambient temperatures are low in the temperature range up to the first predetermined temperature.

By determining the switching interval for power generation of the first FC stack 1 and the second FC stack 2 using the map illustrated in FIG. 9 as illustrated in FIGS. 10A and 10B, a switching frequency of the first FC stack 1 and the second FC stack 2 is higher when the ambient temperatures of the first FC stack 1 and the second FC stack 2 are low than when the ambient temperatures are high.

According to the third embodiment, as illustrated in FIGS. 10A and 10B, the control unit 10 performs switching from stopped power generation to power generation by setting the power generation stopped time of the first FC stack 1 to be shorter when the ambient temperature of the first FC stack 1 is a low temperature within the temperature range up to the first predetermined temperature than when the ambient temperature is a high temperature within the temperature range. In this way, by controlling the switching interval of the first FC stack 1 between stopped power generation and power generation depending on the ambient temperature of the first FC stack 1, it is possible to prevent liquid water in the first FC stack 1 from freezing and to curb an increase in power consumption by decreasing the switching frequency between stopped power generation and power generation.

In the first to third embodiments, when the required power is less than the predetermined threshold value, the ambient temperature of the first FC stack 1 is equal to or lower than the first predetermined temperature, the first FC stack 1 stops its power generation, and the temperature of the first FC stack 1 becomes equal to or lower than a second predetermined temperature, the control unit 10 may switch the first FC stack 1 from stopped power generation to power generation. The temperature of the first FC stack 1 can be acquired based on a temperature detection signal from the temperature sensor 85 as described above. The second predetermined temperature can be set to a temperature at which liquid water in the first FC stack 1 may freeze such as 0° C. or a temperature of a range of 0° C.±2° C. Accordingly, it is possible to effectively prevent liquid water in the first FC stack 1 from freezing. Similarly, regarding the second FC stack 2, when the second FC stack 2 stops its power generation and the temperature of the second FC stack 2 becomes equal to or lower than a third predetermined temperature, the second FC stack 2 may be switched from stopped power generation to power generation. The third predetermined temperature can be set to a temperature at which liquid water in the second FC stack 2 may freeze such as 0° C. or a temperature of a range of 0° C.±2° C.

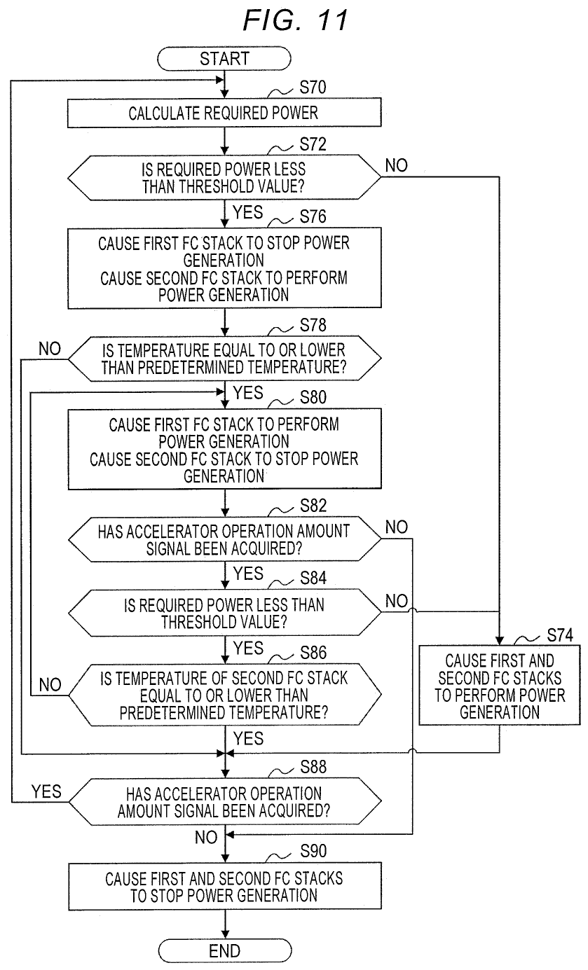

A configuration of a fuel cell system according to a fourth embodiment is the same as illustrated in FIG. 1 according to the first embodiment, and an electrical configuration thereof is the same as illustrated in FIG. 2 according to the first embodiment, and thus description thereof will not be repeated. FIG. 11 is a flowchart illustrating power generation control according to the fourth embodiment. The flowchart illustrated in FIG. 11 is performed, for example, when required power for the overall FC stacks is equal to or greater than a predetermined threshold value. As illustrated in FIG. 11, the control unit 10 calculates required power for the overall FC stacks based on an accelerator operation amount signal with a nonzero operation amount (Step S70).

Subsequently, the control unit 10 determines whether the calculated required power is less than a predetermined threshold value (Step S72). When it is determined in Step S72 that the required power is equal to or greater than the threshold value (NO in Step S72), the control unit 10 causes both the first FC stack 1 and the second FC stack 2 to perform power generation such that the required power is satisfied (Step S74).

On the other hand, when it is determined in Step S72 that the required power is less than the threshold value (YES in Step S72), the control unit 10 causes the first FC stack 1 to stop power generation and causes the second FC stack 2 to perform power generation such that the required power is satisfied by the second FC stack 2 (Step S76). Subsequently, the control unit 10 determines whether the temperature of the first FC stack 1 that stops its power generation is equal to or lower than a predetermined temperature based on the temperature at which liquid water in the first FC stack 1 freezes (Step S78). As described above, the temperature of the first FC stack 1 can be acquired based on a temperature detection signal from a temperature sensor 85. The predetermined temperature may set to 0° C., a temperature within a range of 0° C.±5° C., or a temperature within a range of 0° C.±2° C.

When it is determined in Step S78 that the temperature of the first FC stack 1 is not equal to or lower than the predetermined temperature (NO in Step S78), the control unit 10 determines whether an accelerator operation amount signal with a nonzero operation amount continues to be acquired from an accelerator pedal sensor 57 (Step S88). When an accelerator operation amount signal with a nonzero operation amount continues to be acquired (YES in Step S88), the control unit 10 returns to Step S70.

On the other hand, when it is determined in Step S78 that the temperature of the first FC stack 1 is equal to or lower than the predetermined temperature (YES in Step S78), the control unit 10 causes the second FC stack 2 to stop power generation and causes the first FC stack 1 to perform power generation such that the required power is satisfied by the first FC stack 1 (Step S80). Subsequently, the control unit 10 determines whether an accelerator operation amount signal with a nonzero operation amount continues to be acquired from the accelerator pedal sensor 57 (Step S82). When an accelerator operation amount signal with a nonzero operation amount is not acquired in Step S82 (NO in Step S82), the control unit 10 causes the first FC stack 1 and the second FC stack 2 to stop power generation (Step S90) and ends this power generation control. When an accelerator operation amount signal with a nonzero operation amount is acquired (YES in Step S82), the control unit 10 determines whether the required power is less than the threshold value (Step S84).

When it is determined in Step S84 that the required power is equal to or greater than the threshold value (NO in Step S84), the control unit 10 causes both the first FC stack 1 and the second FC stack 2 to perform power generation such that the required power is satisfied (Step S74). On the other hand, when it is determined in Step S84 that the required power is less than the threshold value (YES in Step S84), the control unit 10 determines whether the temperature of the second FC stack 2 that stops its power generation is equal to or lower than a predetermined temperature based on the temperature at which liquid water in the second FC stack 2 freezes (Step S86). As described above, the temperature of the second FC stack 2 can be acquired based on a temperature detection signal from a temperature sensor 95. The predetermined temperature may set to 0° C., a temperature within a range of 0° C.±5° C., or a temperature within a range of 0° C.±2° C.

When it is determined in Step S86 that the temperature of the second FC stack 2 is not equal to or lower than the predetermined temperature (NO in Step S86), the control unit 10 returns to Step S80. On the other hand, when it is determined in Step S86 that the temperature of the second FC stack 2 is equal to or lower than the predetermined temperature (YES in Step S86), the control unit 10 performs Step S88. When an accelerator operation amount signal with a nonzero operation amount is not acquired in Step S88 (NO in Step S88), the control unit 10 causes the first FC stack 1 and the second FC stack 2 to stop power generation (Step S90) and ends this power generation control.

According to the fourth embodiment, the control unit 10 causes the first FC stack 1 to temporarily stop power generation when the required power is less than the predetermined threshold value, and switches the first FC stack 1 from stopped power generation to power generation when the temperature of the first FC stack 1 is equal to or lower than a predetermined temperature based on the temperature at which liquid water in the first FC stack 1 freezes. Accordingly, it is possible to prevent liquid water in the first FC stack 1 from freezing.

According to the fourth embodiment, when the required power is less than the predetermined threshold value, the control unit 10 causes the second FC stack 2 to perform power generation when the first FC stack 1 stops power generation, and causes the second FC stack 2 to stop power generation when the first FC stack 1 performs power generation. Then, when the second FC stack 2 stops power generation and the temperature of the second FC stack 2 is equal to or lower than a predetermined temperature based on the temperature at which liquid water in the second FC stack 2 freezes, the control unit 10 switches the second FC stack 2 from stopped power generation to power generation. Accordingly, it is possible to prevent liquid water in the second FC stack 2 from freezing.

The predetermined temperature in Steps S78 and S86 of FIG. 11 may be set to 0° C., a temperature within a range of 0° C.±5° C., or a temperature within a range of 0° C.±2° C. Even when the predetermined temperature is set to a value higher than 0° C., it is possible to reliably prevent liquid water in the first FC stack 1 and the second FC stack 2 from freezing. When the predetermined temperature is set to a value lower than 0° C., liquid water in the first FC stack 1 and the second FC stack 2 do not freeze immediately and thus it is possible to prevent liquid water in the first FC stack 1 and the second FC stack 2 from freezing.

In the first to fourth embodiments, a fuel cell unit including two fuel cell stacks is provided in a fuel cell system, but a fuel cell unit including three or more fuel cell stacks may be provided. In this case, two fuel cell stacks out of the fuel cell stacks included in the fuel cell unit have only to correspond to the first FC stack 1 and the second FC stack 2.

While embodiments of the disclosure have been described above, the disclosure is not limited to any specific embodiment and can be modified and changed in various forms without departing from the gist of the disclosure defined by the appended claims.

What is claimed is:

1. A fuel cell system comprising:
a fuel cell unit including a first fuel cell stack and a second fuel cell stack;
a temperature acquiring unit configured to acquire an ambient temperature of the first fuel cell stack; and
a power generation control unit configured to control power generation of the first fuel cell stack and the second fuel cell stack based on required power for the fuel cell unit,
wherein the power generation control unit is configured to, when the required power is less than a predetermined threshold value, temporarily stop power generation of the first fuel cell stack and to switch the first fuel cell stack from stopped power generation to power generation when a continuous power generation stopped time of the first fuel cell stack is greater than a predetermined time such that the continuous power generation stopped time is shorter when the temperature acquired by the temperature acquiring unit is equal to or lower than a first predetermined temperature based on a temperature at which liquid water in the first fuel cell stack freezes than when the temperature acquired by the temperature acquiring unit is higher than the first predetermined temperature.

2. The fuel cell system according to claim 1, wherein the power generation control unit is configured to, when the required power is less than the predetermined threshold value and the temperature acquired by the temperature acquiring unit is equal to or lower than the first predetermined temperature, cause the first fuel cell stack to alternately perform power generation and stop power generation, cause the second fuel cell stack to perform power generation when the first fuel cell stack has stopped power generation, and cause the second fuel cell stack to stop power generation when the first fuel cell stack performs power generation.

3. The fuel cell system according to claim 1, wherein the power generation control unit is configured to cause the first fuel cell stack to keep power generation stopped and to cause the second fuel cell stack to continue power generation when the required power is less than the predetermined threshold value and a state in which the temperature acquired by the temperature acquiring unit is higher than the first predetermined temperature is maintained.

4. The fuel cell system according to claim 1, wherein the power generation control unit is configured to, when the required power is less than the predetermined threshold value, cause the first fuel cell stack and the second fuel cell stack to alternately perform power generation regardless of the temperature acquired by the temperature acquiring unit and to set a switching interval between stopped power generation and power generation of the first fuel cell stack and the second fuel cell stack to be longer when the temperature acquired by the temperature acquiring unit is higher than the first predetermined temperature than when the temperature acquired by the temperature acquiring unit is equal to or lower than the first predetermined temperature.

5. The fuel cell system according to claim 1, wherein the power generation control unit is configured to set the predetermined time to be shorter when the temperature acquired by the temperature acquiring unit is a low temperature within a temperature range than when the temperature acquired by the temperature acquiring unit is a high temperature within the temperature range, the temperature range being a temperature range up to the first predetermined temperature.

6. The fuel cell system according to claim 1, wherein the temperature acquiring unit is configured to further acquire a temperature of the first fuel cell stack, and
wherein the power generation control unit is configured to, when the required power is less than the predetermined threshold value and the ambient temperature of the first fuel cell stack acquired by the temperature acquiring unit is equal to or lower than the first predetermined temperature, switch the first fuel cell stack from stopped power generation to power generation when the temperature of the first fuel cell stack acquired by the temperature acquiring unit becomes equal to or lower than a second predetermined temperature in a state in which the first fuel cell stack has stopped power generation.

7. A fuel cell system comprising:
a fuel cell unit including a first fuel cell stack and a second fuel cell stack;
a temperature acquiring unit configured to acquire a temperature of the first fuel cell stack; and
a power generation control unit configured to control power generation of the first fuel cell stack and the second fuel cell stack based on required power for the fuel cell unit,
wherein the power generation control unit is configured to, when the required power is less than a predetermined threshold value, temporarily stop power generation of the first fuel cell stack and switch the first fuel cell stack from stopped power generation to power generation when the temperature of the first fuel cell stack acquired by the temperature acquiring unit is equal to or lower than a predetermined temperature based on a temperature at which liquid water in the first fuel cell stack freezes.

8. The fuel cell system according to claim 7, wherein the temperature acquiring unit is configured to further acquire a temperature of the second fuel cell stack, and
wherein the power generation control unit is configured to, when the required power is less than the predetermined threshold value, cause the second fuel cell stack to perform power generation when the first fuel cell stack has stopped power generation, cause the second fuel cell stack to stop power generation when the first fuel cell stack performs power generation, and to switch the second fuel cell stack from stopped power generation to power generation when the temperature of the second fuel cell stack acquired by the temperature acquiring unit when the second fuel cell stack has stopped power generation is equal to or lower than a predetermined temperature based on a temperature at which liquid water in the second fuel cell stack freezes.
